(19) United States
(12) Patent Application Publication
(10) Pub. No.: US 2021/0008830 A1
(43) Pub. Date: Jan. 14, 2021

(54) METHOD OF MAKING A FIBROUS PREFORM AND A FIBROUS PREFORM THUS OBTAINED

(71) Applicant: FRENI BREMBO S.P.A., CURNO (BERGAMO) (IT)

(72) Inventor: OMAR CIVIDINI, CURNO (BERGAMO) (IT)

(73) Assignee: FRENI BREMBO S.P.A., CURNO (BERGAMO) (IT)

(21) Appl. No.: 16/982,097

(22) PCT Filed: Mar. 13, 2019
(86) PCT No.: PCT/IB2019/052045

§ 371 Date: Sep. 18, 2020

(30) Foreign Application Priority Data
Mar. 19, 2018 (IT) 102018000003741

(51) Int. Cl. B32B 5/06; B32B 5/02; B32B 5/26; B32B 7/09; F16D 65/12; F16D 69/02

(52) U.S. Cl. CPC B32B 5/06; B32B 5/022; B32B 5/024; B32B 5/26; B32B 7/09; F16D 2065/132; F16D 69/023; B32B 2262/106; B32B 2475/00; B32B 2605/00; F16D 65/126

(57) ABSTRACT

A method of making a fibrous preform in carbon and/or fibres of a carbon precursor may include superposing at least two layers of carbon fibres and/or fibres of a carbon precursor according to a predefined superposition axis Z so as to form a multilayer body. The method may also include needle-punching via least one first needle-punching device the multilayer body in a needle-punching direction substantially parallel to the superposition axis Z to arrange at least part of the fibres parallel to the superposition axis Z, so as to obtain a needle-punched multilayer body. An optional step may include superposing with each other according to the superposition axis Z two or more of the needle-punched multilayer bodies, obtained separately by applying the above steps.

### FIELD OF APPLICATION

The present invention relates to a method for making a fibrous preform and a fibrous preform thus obtained.

The fibrous preform according to the invention can be used as a reinforcing element of C/C (carbon/carbon) braking system components, in particular disc brakes of cars or rotors/stators of aeronautical brakes. In this case, it is intended to be densified by impregnation with resins or pitches or by gaseous deposition, to obtain carbon/carbon structures.

### PRIOR ART

As is known, in the aeronautical field and in the field of racing cars, braking systems are made using carbon/carbon (C/C) components, in particular rotors/stators and disc brakes.

The carbon/carbon components consist of a carbon matrix in which carbon reinforcing fibres are arranged.

Typically, the carbon or carbon precursor fibre is aggregated (alone or with the use of binders, for example resins) to form a three-dimensional structure called “preform”. The most used carbon precursors are PAN, pitch and rayon.

The carbon matrix may be obtained in various ways, essentially attributable to two categories: by impregnation of resin and/or pitch of the fibrous structure or by gas (CVD, “Chemical Vapor Deposition”).

The presence of additives, added in specific steps of the production process, may be provided, in order to improve intermediate producibility or final product features, such as friction coefficient and/or wear resistance.

The known methods in use for the production of carbon fibre preforms include:
impregnation and/or moulding of short fibres (chop) with resins;
impregnation and/or moulding of woven or non-woven felts with resins;
needle punching of nonwoven felts, possibly enriched with continuous fibres;
needle punching of short fibres (chop);
needle punching of carbon or carbon precursor fabrics; and
sewing of fabrics.

As is known, some of the crucial features of the finished brake disc, obtained starting from a carbon fibre preform, strongly depend on the way the preform is made.

In particular, features such as compression strength/stiffness along the rotation axis Z of the disc (orthogonal to the disc plane), shear strength with respect to the disc plane, and thermal conductivity along the axis Z are strongly dependent on the amount and distribution of fibres directed along the axis Z.

Production methods based on impregnation/moulding involve the almost total absence of fibres along the axis Z, resulting in very modest values of the features described above. Typically, these production methods are adopted due to their low cost and production simplicity, but the final technical and qualitative result is decidedly poor.

Alternative production methods, such as sewing, involve a limited presence of fibres along the axis Z, which are moreover not very evenly distributed.

Methods such as needle-punching allow, instead, effectively and homogeneously distributing fibres on the axis Z.

At the same time, the quantity, the distribution of fibres, and the number of layers on the plane of the disc strongly influence final features such as the flexural strength and the thermal conductivity on the disc plane.

The needle-punching of non-woven fabrics or chop fibres does not allow to have a high number of fibres on the plane of the disc, given the randomness of the fibre arrangement and the low density thereof, nor the presence of sufficiently long fibres, arranged in an optimal manner with respect to the stresses to which the disc is subject in use.

The needle-punching of fabrics improves the arrangement and the quantity of fibres arranged in the disc plane, but involves a forced damage to part of the fibres themselves, often reducing the mechanical and thermal features in the disc plane in an uncontrollable manner.

To date, therefore, in the prior art there is no method available for manufacturing preforms of carbon fibres which allows the fibres to be distributed in a controlled manner both on the main plane of the preform and orthogonally to such a plane, without causing damage to the fibres themselves.

It is therefore very felt in the field of the production of braking systems, and in particular of fibre-reinforced CC brake discs, the need to have a method for making preforms of carbon fibres which allows a controlled distribution of the fibres both on the main plane of the preform, and orthogonally to such a plane, without causing damage to the fibres themselves.

### DISCLOSURE OF THE INVENTION

Such a need is met by a method for making a fibrous preform according to claim 1.

In particular, such a need is met by a method of making a fibrous preform in carbon and/or fibres of a carbon precursor, comprising:
a step a) of superposing at least two layers of carbon fibres and/or fibres of a carbon precursor according to a predefined superposition axis so as to form a multilayer body;
a step b) of needle-punching by means of least one first needle-punching device the multilayer body in a needle-punching direction substantially parallel to the superposition axis to arrange at least part of the fibres parallel to the superposition axis, so as to obtain a needle-punched multilayer body,
an optional step c) of superposing with each other according to the superposition axis two or more of the needle-punched multilayer bodies, obtained separately by applying the above steps a) and b).

The fibrous preform 1 consists of a single, multi-layer, needle-punched body or two or more needle-punched multilayer bodies, superposed with each along the superposition axis.

In the superposition step a), the multilayer body is made by superposing one or more layers of fibre in the non-woven form on one or more layers of fibre in the woven form.

In the needle-punching step b) the first portion of the multilayer body to encounter the needles of the first needle-punching device consists of at least one non-woven layer in order to prevent the needles from directly engaging the fibres of the woven layers underneath and in such a way that the fibres to be arranged parallel to the superposition axis belong to the above first portion consisting of at least one layer of fibre in non-woven form.

Preferably, the needles of the aforesaid first needle-punching device are each provided with one or more barbs suitable for engaging one or more fibres. The aforementioned needle-punching step b) is carried out taking into account the number and size of the barbs, as well as the fibre diameter and the weight of said at least one layer of non-woven fibres which constitutes the aforementioned first portion, so that the needles engage only the fibres of the first portion through the barbs.

Advantageously, the density and orientation of the fibres arranged in the above one or more woven layers are chosen according to the density and orientation of the fibres desired for the fibrous preform on planes orthogonal to the superposition axis.

Advantageously, the number of fibres arranged by needle-punching parallel to the needle-punching direction is chosen depending on the density of fibres which is desired to obtain inside the fibrous preform arranged parallel to the superposition axis.

Advantageously, in the above needle-punching step b) the average number of fibres to be arranged in parallel to the above superposition axis per surface unit is controlled by adjusting the needle-punching density (stitch density) depending on the size and number of needle barbs, as well as on the diameter of the fibres and the weight of said at least one layer of non-woven fibres which constitutes the first portion of the multilayer body.

Advantageously, the needle-punching step b) is carried out by differentiating the needle-punching density depending on the spatial position in the preform in order to differentiate the average number of fibres arranged parallel to the above superposition axis per surface unit depending on the spatial position in the preform.

Preferably, in the above superposition step a), the multilayer body is made by superposing a single layer of fibres in the non-woven form on a single layer of fibres in the woven form.

In the above superposition step a), the multilayer body may be made by superposing two or more layers of fibre in the non-woven form on one or more layers of fibre in the woven form.

In the superposition step a), the multilayer body may be made by superposing one or more layers of fibre in the non-woven form on two or more layers of fibre in the woven form.

Preferably, the non-woven layers NW have a lower weight than the weight of the woven layers.

In particular, the non-woven layers each have a weight ranging from 50 to 500 g/m2. The woven layers each have a weight of between 100 and 1000 g/m2.

Preferably, each of the woven layers has a weaving extension parallel to the surface extension plane of the layer. In particular, the woven layers may have a twill weaving or a plain weaving.

According to a preferred embodiment of the invention, the fibrous preform comprises at least two layers of fibres in woven form. Such two woven layers are part of the same needle-punched multilayer body or of two different needle-punched multilayer bodies. The aforementioned at least two woven layers are arranged with respect to one another with the weft of the fibres rotated by a predefined angle around the superposition axis with respect to the weft of the other woven layer.

Preferably, at least a part of the non-woven layers or all the non-woven layers consist of short fibres.

At least a part of the non-woven layers or all the non-woven layers may consist of fibres defined by continuous filaments.

The fibre layers may be made of fibres having the same features or of mixtures of different fibres.

Advantageously, the method according to the invention may comprise a step d) of shaping the fibrous preform carried out by cutting the aforementioned layers of fibres.

Advantageously, the method according to the invention may comprise a step e) of carbonization in the case in which the fibres of said layers are at least partly of a carbon precursor.

Advantageously, the method according to the invention may comprise a graphitisation step f).

According to a preferred embodiment, the fibrous preform has cylindrical shape, with axis parallel to the superposition axis of the fibre layers.

In particular, the fibrous preform may have a thickness of between 10 and 80 mm.

In particular, the fibrous preform may have circular cross-section according to a plane orthogonal to the superposition axis and have a diameter of between 200 and 600 mm.

In particular, the fibrous preform has a density (apparent geometric) of between 0.4 and 0.7 g/cm3.

The aforesaid need is met by a fibrous preform of carbon fibres and/or fibres of a carbon precursor, comprising at least two layers of carbon fibres and/or fibres of a carbon precursor superposed on each other according to an overlapping axis. The aforementioned at least two layers of fibres are joined together by needle-punching.

A first layer of the aforementioned two layers of fibres is a layer of fibres in the form of non-woven and a second layer of the aforementioned two layers of fibres is a layer of fibres in woven form. In the aforesaid second layer there is a plurality of fibres which are arranged parallel to the aforesaid superposition axis forming a three-dimensional structure with the fibres of the fabric and which come from the aforesaid first layer having been moved in such a second layer by needle-punching.

Advantageously, the above second woven layer has a weaving extension parallel to the surface extension plane of the layer itself and substantially orthogonal to the superposition axis.

The object of the present invention is also a method of making a fibre-reinforced C/C brake disc by means densification of a fibrous preform. Such a fibrous preform is made by the method according to the invention.

### DESCRIPTION OF THE FIGURES

Further features and advantages of the present invention will appear more clearly from the following description of preferred non-limiting embodiments thereof, in which:

FIG. 1 shows a block diagram of a preferred embodiment of the method according to the invention;

FIG. 2 shows a schematic representation of the operating steps of the method according to the invention in the case in which the fibrous preform is formed by a single needle-punched multilayer body, consisting in turn of a single non-woven layer and a single woven layer;

FIG. 3 shows a schematic representation of the operating steps of the method according to the invention in the case in which the fibrous preform is formed by a single needle-punched multilayer body, consisting in turn of a single non-woven layer and two woven layers;

FIG. 4 shows a schematic representation of the operating steps of the method according to the invention in the case in which the fibrous preform is formed by a single needle-punched multilayer body, consisting in turn of two non-woven layers and a single woven layer;

FIGS. 5 and 6 show a schematic representation of the operating steps of the method according to the invention in the case in which the fibrous preform is formed respectively by two superposed needle-punched multilayer bodies and by n superposed needle-punched multilayer bodies;

FIG. 7 shows a schematic representation of the operating steps of the method according to the invention according to a variant with respect to the case illustrated in FIG. 6, in which an intermediate step of solidification of the layers by light needle-punching is provided;

FIG. 8 shows an example of a needle for needle-punching, with two successive enlargements illustrating the needle barbs;

FIG. 9 schematically shows the arrangement of the fibres following the interaction of the needles of a needle-punching device with a non-woven layer and one or more woven layers; and

FIG. 10 schematically shows the relative rotation of the weaving of two woven layers around a common superposition axis Z.

### DETAILED DESCRIPTION

With reference to the above figures, reference numeral 1 globally denotes a fibrous preform obtained by the method according to the present invention.

The method of making a fibrous preform 1 in carbon and/or fibres of a carbon precursor according to the invention comprises the following operating steps:
a step a) of superposing at least two layers of carbon fibres and/or fibres of a carbon precursor according to a predefined superposition axis Z so as to form a multilayer body 2;
a step b) of needle-punching by means of least one first needle-punching device 10 the above multilayer body 2 in a needle-punching direction substantially parallel to the superposition axis Z to arrange at least part of the fibres parallel to the superposition axis Z, so as to obtain a needle-punched multilayer body 3.

The expression “arrangement parallel to the superposition axis Z” means a prevailing orientation and it is not meant to be limited to provisions in which the fibres are perfectly parallel to such an axis.

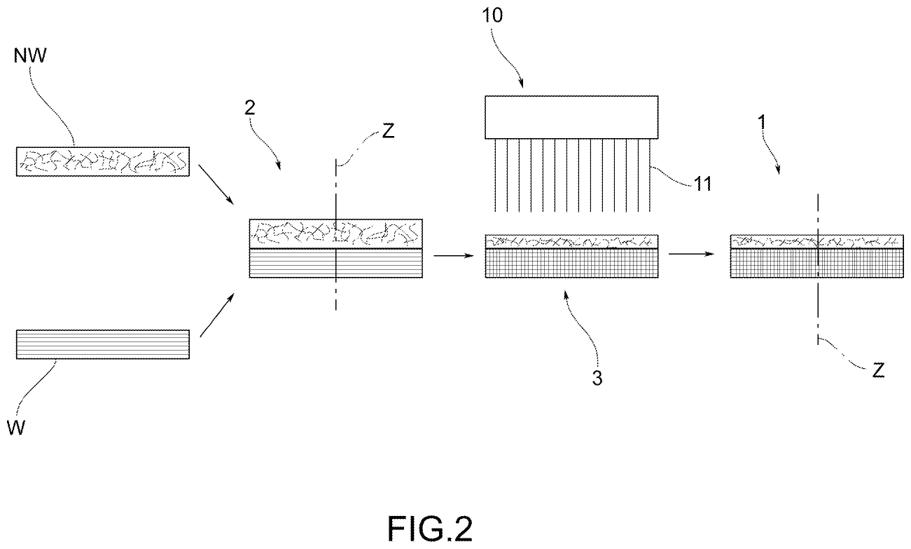

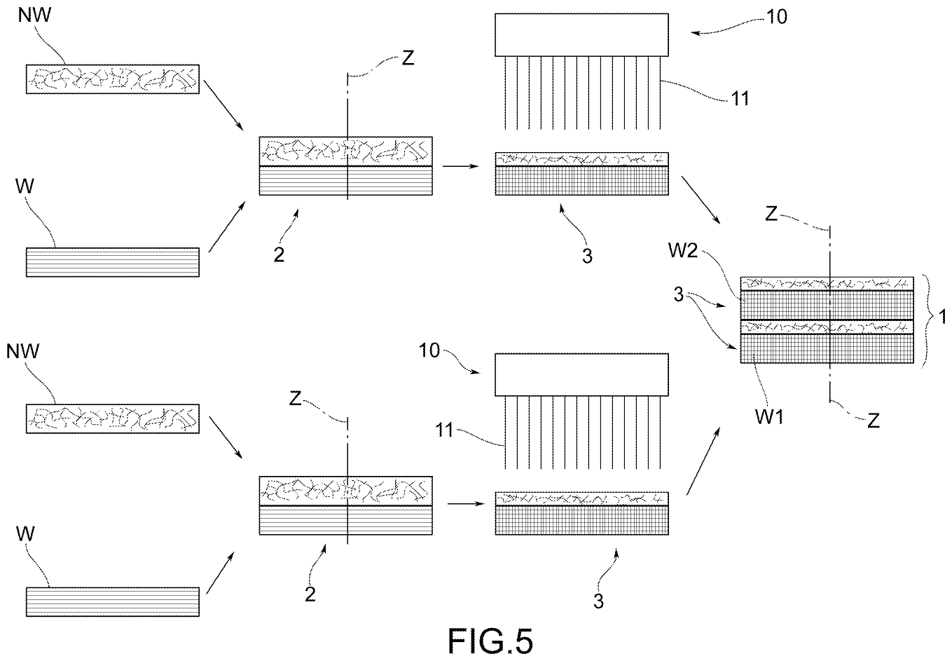

The fibrous preform 1 may consist of a single, multi-layer, needle-punched body 3 (as shown in FIGS. 2, 3 and 4) or two or more needle-punched multilayer bodies 3, superposed with each along the superposition axis Z (as shown in FIGS. 5, 6 and 7).

In the case in which the fibrous preform 1 consists of two or more needle-punched multilayer bodies 3, the method according to the invention comprises an optional step c) of superposing two or more of the aforesaid multi-layer needle-punched bodies according to the superposition axis Z 3, obtained separately by applying said steps a) and b).

According to a first aspect of the present invention, in the aforementioned superposition step a), the multilayer body 2 is made by superposing one or more layers of fibre in the non-woven form NW on one or more layers of fibre in the woven form W, as schematically illustrated in the accompanying figures.

According to a further aspect of the present invention, in the above needle-punching step b) the first portion of the multilayer body 2 to encounter the needles 11 of the first needle-punching device 10 consists of at least one non-woven layer NW in order to prevent the needles 11 from directly engaging the fibres of the woven layers W underneath and in such a way that the fibres 20 to be arranged parallel to the above superposition axis Z belong to the first portion consisting of at least one layer of fibre in non-woven form NW.

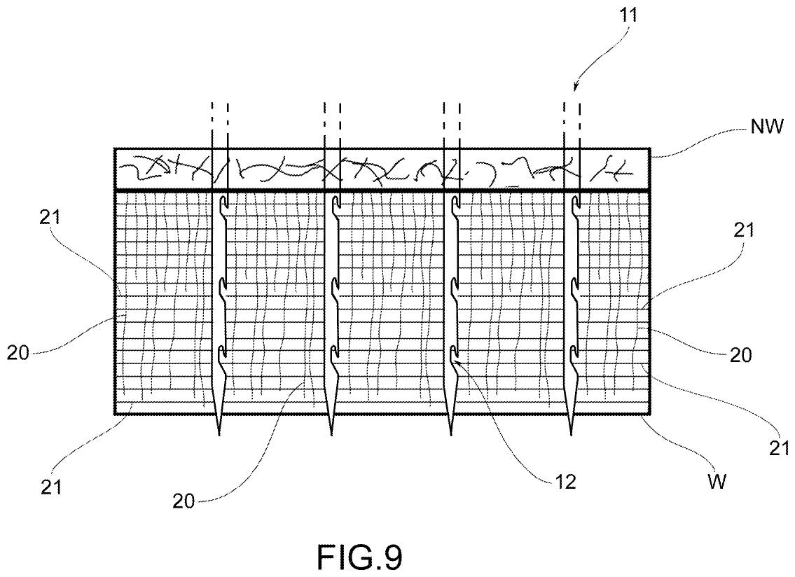

FIG. 9 schematically shows the arrangement of the fibres following the interaction of the needles 11 of a needle-punching device 10 with a non-woven layer and one or more woven layers. More in detail, reference numeral 20 indicates the fibres that come from a non-woven layer NW and have been moved into the underlying woven layers W by needle-punching. Reference numeral 21 schematically indicates the lying/weaving planes of the fibres that form the woven layers.

Advantageously, the fibre layers W, NW used to make the fibrous preform 1 according to the method according to the present invention are not resin-coated in order to:
avoid hindering needle-punching (in the presence of resin, the needles 11 of the first needle-punching device 10 would tend to get dirty and there would be a high risk of frequent plant blockage); and
not limit the “mobility” of the fibres, both in the woven layers and in the non-woven layers.

As will be described below, the single needle-punched multilayer bodies 3 or directly the fibrous preform 1 may be resin-coated after the needle-punching step.

Thanks to the method according to the present invention, it is possible to produce a fibrous preform 1 by controlling the three-dimensional distribution of the fibres therein, without incurring in the limitations of the prior art.

In fact, the arrangement of the fibres on the planes defined by the woven layers W (parallel to each other) can be controlled by suitably selecting the woven type and it is not altered by the needle-punching action due to the presence of the non-woven layers NW which perform in this sense a screening function against the action of the needles. The arrangement of the fibres orthogonally to the planes defined by the fibre layers may be controlled by adjusting the operating parameters of the needle-punching process and the features of the non-woven layers NW.

Assuming that the main plane of the fibrous preform 1 is defined by a plane parallel to the layers of fibres, due to the method according to the present invention it is therefore possible to distribute the fibres in a controlled manner both parallel to such a main plane through the woven layers W, and orthogonally thereto it due to the needle-punching action which orientates at least a part of the fibres of the non-woven layers NW orthogonally to such a plane.

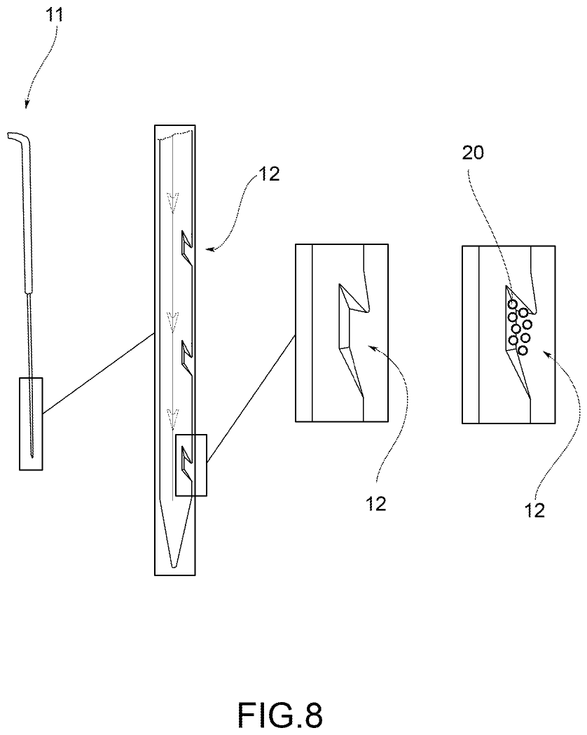

The needles 11 of the aforementioned at least one needle-punching device 10 are each provided with one or more cavities 12, called barbs, suitable for engaging one or more fibres 20, as schematically illustrated in FIG. 8.

More in detail, the barbs 12 are shaped so as to engage and pull down fibres when the needle penetrates the layer, but not to engage and pull fibres when the needle rises and exits from the layer of fibres. The shape of the barbs is specifically designed to perform this function.

The barbs are obtained in the working area of the needle, that is, the portion of needle that penetrates into the layer of fibres and which can therefore act on the fibres.

Operationally, the fibre 20 which has been displaced in the descending step of the needle remains in the position in which it was placed by the needle itself, and is not affected by the upward movement of the needle itself. The needle, coming out of the layer of fibres, exits without pulling fibres therewith.

Advantageously, the aforementioned needle-punching step b) is carried out taking into account both the number and size of the barbs 12 and the fibre diameter and the weight of the above at least one layer of non-woven fibres NW which constitutes the first portion of the multilayer body 2, so that the needles 11 engage only the fibres of said first portion through the barbs 12.

In other words, the aforementioned needle-punching step b) is carried out in such a way that for the whole needle-punching process the needles penetrate the fibre layers and the barbs are filled only with fibres belonging to the non-woven layer or layers NW which form such a first portion [screening layer(s)].

In other words, the needle-punching step b) is conducted in such a way that the quantity of fibres available in the aforementioned at least one layer of non-woven fibres NW which constitutes the first portion of the multilayer body 2 is not less than (higher than or at most equal to) the quantity of fibres transferable by the needles parallel to the needle-punching direction.

Advantageously, the density and orientation of the fibres arranged in said one or more woven layers W are chosen according to the density and orientation of the fibres desired for the fibrous preform 1 on planes orthogonal to the superposition axis Z, i.e. parallel to the main plane of the preform 1 and orthogonal to the thickness of the preform itself.

Advantageously, the quantity of fibres arranged by needle-punching parallel to the needle-punching direction is chosen depending on the density of fibres 20 which is desired to obtain inside the fibrous preform 1, arranged parallel to the superposition axis Z, i.e. orthogonally to the main plane of the preform 1 and aligned along the thickness of the preform itself.

Preferably, in the needle-punching step b) the average number of fibres to be arranged in parallel to the above superposition axis per surface unit is controlled by adjusting the needle-punching density (stitch density) depending on the size and number of needle 11 barbs 12, as well as on the diameter of the fibres and the weight of the above at least one layer of non-woven fibres NW which constitutes the first portion of a multilayer body 2. As already said, such a layer of fibres NW in fact acts as a screen and is intended to provide the fibres to be arranged along the superposition axis Z.

Advantageously, the needle-punching step b) may be carried out by differentiating the needle-punching density depending on the spatial position in the preform in order to differentiate the average number of fibres 20 arranged parallel to the above superposition axis Z per surface unit depending on the spatial position in the preform.

The selection of the number of non-woven NW and woven W layers to be used in the production of a needle-punched multilayer body 3 depends on the various factors linked to the final features that the fibrous preform 1 should have.

For example, this choice may depend on the density value (apparent geometric) and/or on the thickness of the fibrous preform 1.

In particular, the density value is linked (in addition to the needle-punching parameters) also to the weight of the fibre layers initially used. Depending on the features (weight) of the available starting materials (woven layers and non-woven layers) the selected value of weight may be obtained using a single woven/non-woven layer, or it may be obtained by superposing two or more non-woven layers. For example, if it is necessary to use a non-woven with a weight of 150 g/m2 and no single non-woven layers are available with this weight, the result may be achieved with two superposed non-woven layers, one of 100 g/m2 and one of 50 g/m2.

Advantageously, the selection of the number of non-woven layers NW and woven layers W in a multilayer body 3 may be made to control the distribution of the fibres parallel to the main plane of the preform and/or orthogonally thereto. As will be shown below, the above is applied in particular to the woven layers W, the features whereof define the distribution of the fibres parallel to the main plane of the preform.

Preferably (as shown in FIGS. 2, 5, 6 and 7), in the superposition step a), the multilayer body is made by superposing a single layer of fibres in the non-woven form NW on a single layer of fibres in the woven form W.

In other words, preferably, in the superposition step a) the woven layers W and the non-woven layers NW are superposed in a ratio of 1:1. Operationally, this ratio is the ratio which allows an easier control of the needle-punching process and therefore of the final result, intended in terms of control of the quantity of fibres arranged parallel to the superposition axis Z inside the underlying woven layer or layers W.

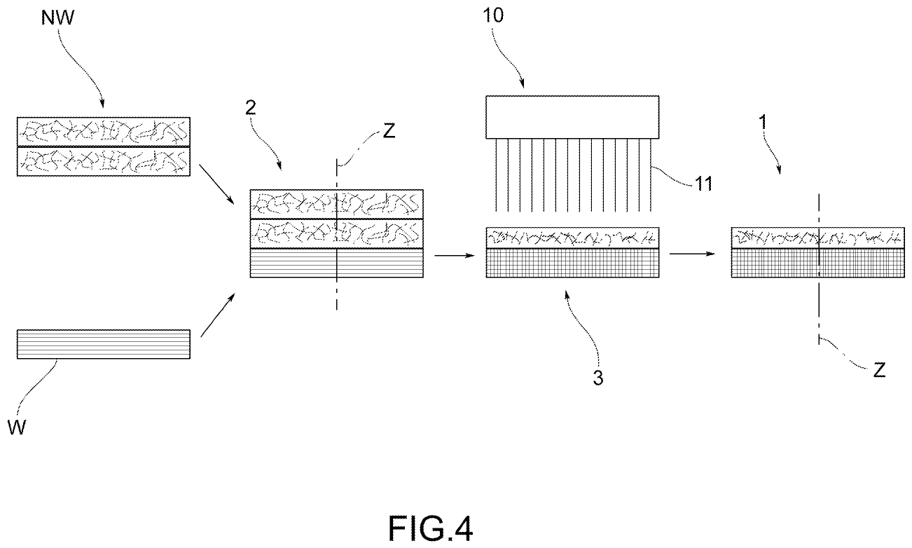

As an alternative (as shown in FIG. 4), in the superposition step a), the multilayer body may be made by superposing two or more layers of fibre in the non-woven form NW on one or more layers of fibre in the woven form W.

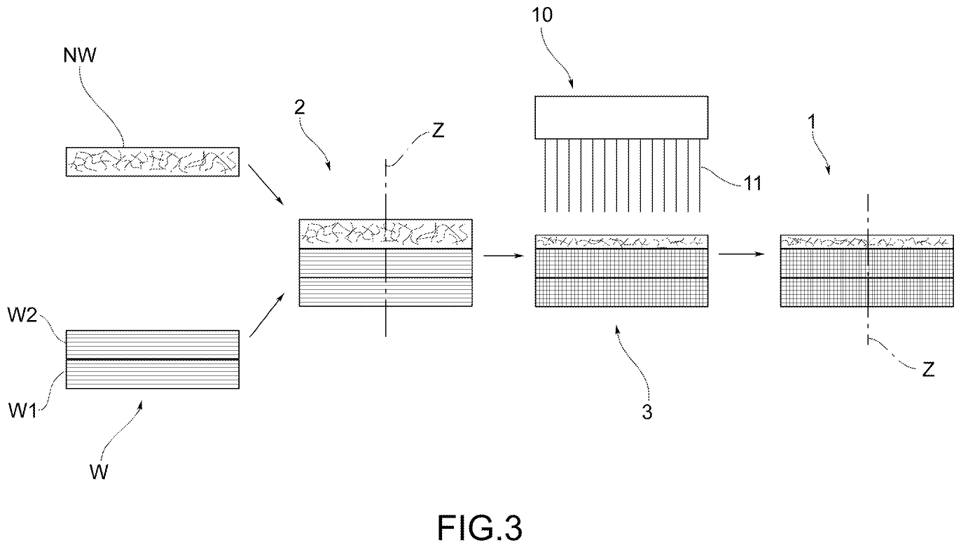

As an alternative (as shown in FIG. 3), in the superposition step a), the multilayer body may be made by superposing one or more layers of fibre in the non-woven form NW on two or more layers of fibre in the woven form w.

In other words, it may be expected that the woven layers W and the non-woven layers NW are superposed with different ratios with respect to the preferred 1:1 one. More in detail, both equal ratios, for example 2:2, 3:3, etc., and non-equal ratios, for example 1:2 or 2:1, 2:3 or 3:2, etc. may be adopted.

In particular, the number of non-woven layers NW and of woven W forming a multilayer body is selected according to the thickness of the single layers used, so that the total thickness of such a multilayer body (given by the sum of the single layers) does not exceed the maximum working needle-punching depth.

The maximum working needle-punching depth is defined by the length of the needles and in particular by the length of the portion in which the barbs are made.

Preferably, in particular in the case in which the fibrous preform 1 is to be used in the production of brake discs, the non-woven layers NW have a weight lower than the weight of the woven layers W. This is due to the fact that the mechanical stresses that a brake disc undergoes are larger on the disc plane (i.e. on the main plane of the preform 1) than on the thickness of the disc (that is, parallel to the superposition direction Z of the preform 1). There is therefore a greater need for fibres on the main plane of the preform 1, than on the thickness of the preform 1.

According to a preferred embodiment of the method according to the invention, the non-woven layers NW have a weight not exceeding half of the weight of the woven layers W.

In particular, the non-woven layers NW each have a weight ranging from 50 to 500 g/m2, while the woven layers W each have a weight of between 100 and 1000 g/m2.

Advantageously, each of the woven layers W has a weaving extension parallel to the surface extension plane of the layer.

By woven layer it is meant a layer of material having an ordered arrangement of the fibres, in which the fibres are all arranged substantially on the same plane.

Preferably, the woven layers W a twill weaving or a plain weaving. The woven layers present in a fibrous preform 1 may all have the same type of weaving or have different types of weaving.

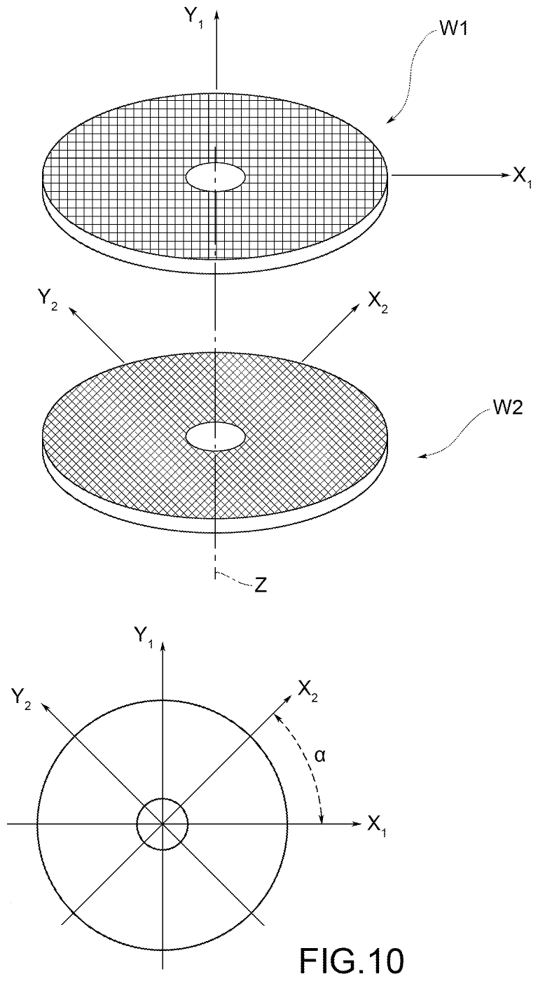

Advantageously, as shown in FIG. 10, in the case in which the fibrous preform 1 as a whole comprises at least two woven layers W1, W2 (whether they are part of the same multilayer body 3 or are part of two different multilayer bodies 3′, 3″), these two woven layers W1, W2 may be arranged with respect to one another with the weaving of the fibres rotated by a predefined angle a around the aforementioned superposition axis Z with respect to the weaving of the other woven layer. Preferably, the aforementioned rotation angle is equal to 45°.

Due to the aforementioned orientation, it is possible to maximize the distribution of the fibres on the main plane of the preform and therefore the final mechanical properties of the manufactured articles (in particular brake discs) which incorporate the fibrous preform 1 as a reinforcement structure.

As is known, the resistance of a brake disc is guaranteed if there is a minimum quantity of long fibre (the woven fibres) in several directions lying on planes parallel to the main plane of the disc itself. For example, referring to the axis of rotation of the disc (superposition axis Z of the preform 1), it is assumed that it will have a long fibre on at least four main directions, all lying on the main plane of the disc and identified with an angular value (see FIG. 10): Y2=0°; Y1=45°; X2=90°; X1=135°.

If only short fibres were used (for example only non-woven) according to some solutions of the prior art, there would be no long fibre and therefore there would in any case be very poor resistance.

If layers of long fibres were used unidirectionally, 4 separate layers would be needed to cover the 4 directions.

The use of two superposed woven layers, with the weaving of the fibres rotated by an angle of 45°, allows the minimum number of layers of long fibres to be reduced to two to cover the aforementioned four directions. It should be noted that by applying the method according to the present invention, i.e. by providing a needle-punching in the presence of a protective non-woven layer, the long fibres of the two woven layers are not damaged and the long fibre amount useful for the mechanical strength of disc is not reduced. Otherwise, if the method according to the invention is not applied (i.e. a non-woven protection/screening layer is not provided), part of the long fibre would be damaged. Therefore, in order to obtain an equivalent useful long fibre distribution on the main plane of the disc it would be necessary to increase the number of layers.

Thanks to the invention, being the quantity of long useful fibre distributed on the main plane of the preform (and therefore of the brake disc) equal, it is possible to limit the number of layers to two and therefore reduce the thickness of the preform and therefore also of the brake disc. The reduction in thickness allows for significant savings in terms of weight and ventilation of the disc.

Preferably, at least a part of the non-woven layers NW or all the non-woven layers NW consist of short fibres.

“Short fibre” means a fibre of predefined/discrete length. Advantageously, the length of the short fibres may be selected depending on the thickness of the underlying woven layer(s) and the depth with which the fibres coming from the non-woven layer NW must penetrate into the woven layer W.

Non-woven layers NW with short fibres may be obtained by any technique suitable for the purpose. Preferably, these layers are obtained starting from staple fibres.

Alternatively, at least a part of the non-woven layers NW or all such non-woven layers NW may consist of fibres in the form of continuous filaments.

The fibre layers (woven W and non-woven NW) may be made of fibres having the same features or of mixtures of different fibres. The fibres may vary in type and features both within the same layer and between layer and layer.

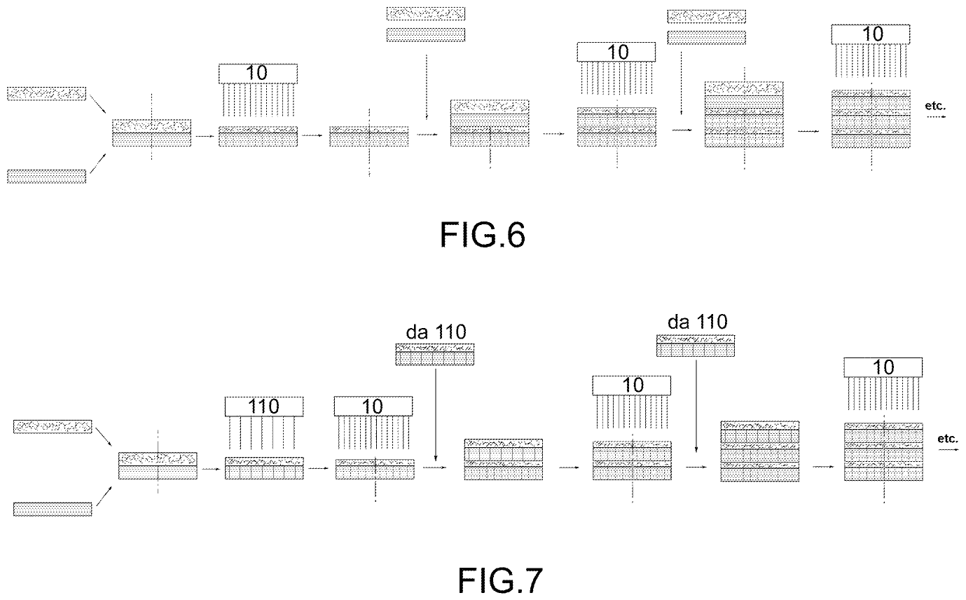

Advantageously, as shown in FIG. 7, after the superposition step a) and before the needle-punching step b), the method may comprise an intermediate step of solidification of the superposed layers of fibres which form the multilayer body. This intermediate (optional) solidification step is aimed at connecting the various layers to each other and facilitate the manipulation of the multilayer body 2, before the needle-punching step b).

In particular, this intermediate solidification step is useful when the fibrous preform 1 consists of two or more needle-punched multilayer bodies 3 and a manipulation of the multilayer bodies 2 is required before the needle-punching step b).

Preferably, this intermediate solidification step may be performed by sewing or, even more preferably, by light needle-punching. By light needle-punching it is meant a needle-punching conducted with a needle-punching density much lower than that expected in the needle-punching step b). Advantageously, even the “light” needle-punching is carried out in such a way as to protect the woven layers W with one or more non-woven layers NW.

In particular, as illustrated in FIG. 7, the intermediate solidification step by light needle-punching is carried out with a second needle-punching device 110, specifically dedicated to the purpose.

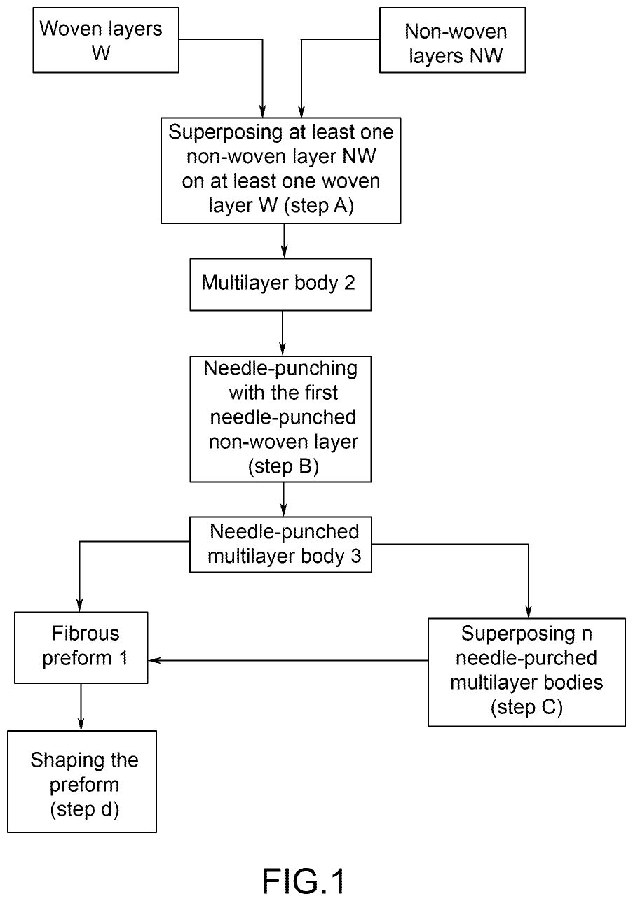

Advantageously, as shown in FIG. 1, the method according to the present invention may comprise a step d) of shaping the fibrous preform 1 carried out by cutting the aforementioned layers of fibres.

The shaping operation may be carried out on the single fibre layers, before the superposition steps a) and b), or it may be carried out on the single needle-punched multilayer bodies 3 or (if the preform is formed by two or more needle-punched multilayer bodies) directly on the fibrous preform 1 (as contemplated in the diagram in FIG. 1).

As already mentioned, the fibres may be in carbon or in a carbon precursor (preferably PAN, pitch, or rayon).

If the fibres are at least partly of a carbon precursor, the method according to the present invention may comprise a carbonization step e), aimed at transforming the carbon precursor fibres into carbon fibres. In particular, the carbonization involves heating the fibres to a temperature of between 1,500° C. and 2000° C., which varies according to the type of precursor.

Advantageously, the method according to the present invention may comprise a graphitisation step e) of the fibrous preform. In particular, the graphitisation involves heating the carbon fibres at a temperature of between 2,000° C. and 3000° C. The graphitisation allows varying the mechanical and thermal features of the fibres (and therefore partly also the finished object that will incorporate such fibres). In particular, the graphitisation increases the modulus of elasticity of carbon fibres.

The dimensions of the fibrous preform 1 obtained according to the present invention may vary according to the final application of the fibrous preform 1.

Advantageously, as will be shown below, a fibrous preform 1 made with the method according to the present invention may be used in the production of C/C brake discs as a reinforcement structure. In this case, the fibrous preform is shaped so as to have a cylindrical shape, with its axis parallel to the superposition axis Z of the fibre layers. In this way, the woven layers W are arranged parallel to the disc plane and the fibres oriented by needle-punching are orthogonal to the disc plane itself.

In particular, the fibrous preform may have a thickness of between 10 and 80 mm.

In particular, the fibrous preform may have circular cross-section according to a plane orthogonal to the superposition axis Z and may have a diameter of between 200 and 600 mm.

In particular, the fibrous preform has a density (apparent geometric) of between 0.4 and 0.7 g/cm3.

The object of the present invention is a fibrous preform 1 in carbon fibres and/or fibres of a carbon precursor.

The fibrous preform 1 comprises at least two layers of carbon fibres and/or fibres of a carbon precursor superposed on each other according to a superposition axis Z. The aforementioned at least two layers of fibres are joined together by needle-punching.

According to the invention, a first layer NW of such two layers of fibres is a layer of fibres in non-woven form NW and a second layer of such two layers of fibres is a layer in woven form W.

In the second layer W there are a plurality of fibres 20 which are arranged parallel to the superposition axis Z forming a three-dimensional structure with the woven fibres. The fibres 20, which are arranged parallel to the superposition axis Z and form a three-dimensional structure with the woven fibres come from the aforesaid first layer NW having been moved in the second layer W by needle-punching.

The dimensions of the fibrous preform 1 may vary according to the final application of the fibrous preform 1.

Advantageously, as will be resumed below, a fibrous preform 1 according to the present invention may be used in the production of C/C brake discs as a reinforcement structure. In this case, the fibrous preform is shaped so as to have a cylindrical shape, with its axis parallel to the superposition axis Z of the fibre layers. In this way, the woven layers W are arranged parallel to the disc plane and the fibres oriented by needle-punching are orthogonal to the disc plane itself.

In particular, the fibrous preform 1 may have a thickness of between 10 and 80 mm.

In particular, the fibrous preform 1 may have circular cross-section according to a plane orthogonal to the superposition axis Z and may have a diameter of between 200 and 600 mm.

In particular, the fibrous preform has a density (apparent geometric) of between 0.4 and 0.7 g/cm3.

Preferably, this fibrous preform 1 is made according to the method according to the invention, in particular as described above. For the sake of simplicity, what has been described in relation to the manufacturing method is also considered to refer to the fibrous preform 1 and for simplicity of description it will not be described again.

The object of the present invention is also a method of making a fibre-reinforced C/C brake disc by means densification of a fibrous preform.

The fibrous preform subjected to densification is a fibrous preform 1 according to the invention.

Preferably, the aforesaid fibrous preform 1 is made by the method according to the present invention, and in particular as described above.

Advantageously, the aforesaid fibrous preform 1 has the shape of the brake disc to be obtained. Alternatively, the aforesaid fibrous preform 1 may also have a shape not corresponding to that of the brake disc, for example it may define an inner reinforcement ring of the disc, having a limited extension with respect to that of the disc itself.

Preferably, the densification is carried out by CVD/CVI gas deposition or by impregnation with resins and/or pitches.

As can be understood from the description, the method according to the invention allows overcoming the drawbacks of the prior art.

As already mentioned, thanks to the method according to the present invention, it is possible to produce a fibrous preform by controlling the three-dimensional distribution of the fibres therein, without incurring in the limitations of the prior art and in particular without incurring damage to the fibres caused by the needle-punching.

Thanks to the method according to the present invention, in fact, the arrangement of the fibres on the planes defined by the woven layers (parallel to each other) can be controlled by suitably selecting the woven type and it is not altered by the needle-punching action due to the presence of the non-woven layers which perform in this sense a screening function.

The arrangement of the fibres orthogonally to the planes defined by the fibre layers may be controlled by adjusting the operating parameters of the needle-punching process and the features of the non-woven layers.

All this makes the method according to the present invention particularly suitable for making fibrous preforms in carbon fibres intended to be used as reinforcement structures in the production of C/C brake discs.

In fact, some of the crucial features of the finished brake disc, obtained starting from a carbon fibre preform, strongly depend on the way the fibrous preform is made. In particular, features such as compression strength/stiffness along the rotation axis Z of the disc (orthogonal to the disc plane), shear strength with respect to the disc plane, and thermal conductivity along the axis Z are strongly dependent on the amount and distribution of fibres directed along the axis Z. Thanks to the method according to the invention it is now possible to control the distribution of the fibres both on the disc plane and parallel to the axis of rotation of the disc itself.

Moreover, thanks to the method of the invention, the control can be carried out reliably and cost-effectively.

The main advantages obtainable with the method according to the present invention are listed below:
integrity of the fibres belonging to the woven layers during needle-punching: thanks to the screening effect provided by the non-woven layers, the needle-punching acts only on fibres belonging to the non-woven layers, pulling them orthogonally to the lying planes of the layers, i.e. along the direction Z;
the needle-punching gives greater dimensional/geometric stability to the fibrous preform, useful in the subsequent production steps;
possibility of rotating the orientation of the woven layers together with the consequent possibility of obtaining a better orthotropy of the properties of the fibrous preform and therefore also of a brake disc made with such a preform;
greater final mechanical strength of the brake disc obtained by using the fibrous preform 1 according to the invention, due to the presence of continuous fibres in the fabric on the disc plane;
possibility of reducing the minimum sections of a brake disc obtained using the fibrous preform 1 according to the invention.

A man skilled in the art may make several changes and adjustments to the method of making fibrous preforms described above in order to meet specific and incidental needs, all falling within the scope of protection defined in the following claims.

1-29. (canceled)

30. A method of making a fibrous preform in carbon and/or fibres of a carbon precursor, comprising:
a step a) of superposing at least two layers of carbon fibres and/or fibres of a carbon precursor according to a predefined superposition axis (Z) so as to form a multilayer body;
a step b) of needle-punching via least one first needle-punching device said multilayer body in a needle-punching direction substantially parallel to said superposition axis (Z) to arrange at least part of the fibres parallel to the superposition axis (Z), so as to obtain a needle-punched multilayer body,
an optional step c) of superposing with each other according to said superposition axis (Z) two or more of said needle-punched multilayer bodies, obtained separately by applying said steps a) and b),
wherein said fibrous preform consists of a single, multi-layer, needle-punched body or two or more needle-punched multilayer bodies, superposed with each along said superposition axis (Z),
wherein in said superposition step a) the multilayer body is made by superposing one or more layers of fibre in the non-woven form on one or more layers of fibre in the woven form,
and wherein in said needle-punching step b) the first portion of the multilayer body to encounter the needles of said first needle-punching device consists of at least one non-woven layer in order to prevent the needles from directly engaging the fibres of the woven layers underneath and in such a way that the fibres to be arranged parallel to said superposition axis (Z) belong to said first portion consisting of at least one layer of fibre in non-woven form.

31. The method according to claim 30, wherein the needles of said first needle-punching device are each equipped with one or more barbs suitable to engage one or more fibres and wherein said needle-punching step b) is carried out taking into account the number and dimensions of said barbs, as well as the diameter of the fibres and the weight of said at least one layer of non-woven fibres which constitutes said first portion, so that the needles engage by means of said barbs only fibres of said first portion.

32. The method according to claim 30, wherein the density and orientation of the fibres arranged in said one or more woven layers are chosen according to the density and orientation of the fibres desired for the fibrous preform on planes orthogonal to the superposition axis (Z).

33. The method according to claim 30, wherein the number of fibres arranged by needle-punching parallel to the needle-punching direction is chosen depending on the density of fibres which is desired to obtain inside the fibrous preform arranged parallel to the superposition axis (Z).

34. The method according to claim 30, wherein in said needle-punching step b) the average number of fibres to be arranged in parallel to said superposition axis per surface unit is controlled by adjusting the needle-punching density depending on the size and number of needle barbs, as well as on the diameter of the fibres and the weight of said at least one layer of non-woven fibres which constitutes said first portion of the multilayer body.

35. The method according to claim 34, wherein the needle-punching step b) is carried out by differentiating the needle-punching density depending on the spatial position in the preform in order to differentiate the average number of fibres arranged parallel to said superposition axis (Z) per surface unit depending on the spatial position in the preform.

36. The method according to claim 30, wherein in said superposition step a) the multilayer body is made by superposing a single layer of fibres in non-woven form on a single layer of fibre in the woven form.

37. The method according to claim 30, wherein in said superposition step a) the multilayer body is made by superposing two or more layers of fibre in non-woven form on one or more layers of fibre in woven form.

38. The method according to claim 30, wherein in said superposition step a) the multilayer body is made by superposing one or more layers of fibre in non-woven form on two or more layers of fibre in woven form.

39. The method according to claim 30, wherein the non-woven layers have a weight less than the weight of the woven layers.

40. The method according to claim 30, wherein the non-woven layers each have a weight of between 50 and 500 g/m2.

41. The method according to claim 30, wherein the woven layers each have a weight of between 100 and 1000 g/m2.

42. The method according to claim 30, wherein each of the woven layers has a weaving extension parallel to the surface extension plane of the layer.

43. The method according to claim 30, wherein the woven layers have a twill or plain weave.

44. The method according to claim 30, wherein said fibrous preform comprises at least two layers of woven fibre, said two woven layers being part of the same needle-punched multilayer body or of two different needle-punched multilayer bodies, and wherein said at least two woven layers are arranged one with respect to the other with the weave of the fibres rotated by a predetermined angle (a) around said superposition axis (Z) with respect to the weave of the other woven layer.

45. The method according to claim 30, wherein at least a portion of said non-woven layers or all said non-woven layers are composed of short fibres.

46. The method according to claim 30, wherein at least a portion of said non-woven layers or all said non-woven layers are made of fibres defined by continuous filaments.

47. The method according to claim 30, wherein the fibre layers consist of fibres having the same characteristics or of blends of different fibres.

48. The method according to claim 30, comprising a step d) of shaping the fibrous preform conducted by cutting out the aforesaid fibre layers.

49. The method according to claim 30, comprising a step e) of carbonization in the case in which the fibres of said layers are at least partly of a carbon precursor.

50. The method according to claim 30, comprising a step f) of graphitisation.

51. The method according to claim 30, wherein the fibrous preform has cylindrical shape, with axis parallel to the superposition axis (Z) of the fibre layers.

52. The method according to claim 30, wherein the fibrous preform has a thickness of between 10 and 80 mm.

53. The method according to claim 30, wherein the fibrous preform has circular cross-section according to a plane orthogonal to the superposition axis (Z) and has a diameter of between 200 and 600 mm.

54. The method according to claim 30, wherein the fibrous preform has an apparent geometric density ranging from 0.4 to 0.7 g/cm3.

55. A fibrous preform in carbon fibre and/or fibres of a carbon precursor comprising at least two layers of carbon fibres and/or fibres of a carbon precursor superposed with each other according to a superposition axis (Z), wherein said at least two layers of fibres are joined by needle-punching, wherein a first layer of said two layers of fibres is a layer of fibres in non-woven form and a second layer of said two layers of fibres is a layer of fibres in woven form, and wherein in said second layer there are a plurality of fibres which are arranged parallel to said superposition axis forming a three-dimensional structure with the woven fibres and which come from said first layer having been moved into said second layer by needle-punching.

56. The fibrous preform according to claim 55, wherein said second woven layer has a weaving extension parallel to the surface extension plane of the layer itself and substantially orthogonal to said superposition axis (Z).

57. A method of making a fibre-reinforced C/C brake disc, by densification of a fibrous preform, wherein said fibrous preform is made by the method according to claim 30.

58. A method of making a fibre-reinforced C/C brake disc, by densification of a fibrous preform, wherein said fibrous preform is a fibrous preform according to claim 55.
